(19) United States
(12) Patent Application Publication
(10) Pub. No.: US 2016/0196519 A1
(43) Pub. Date: Jul. 7, 2016

(54) Dynamic routing through mobile computing

(71) Applicant: MowPay LLC, Jasper, GA (US)

(72) Inventor: Richard Hart Voyentzie, Jasper, GA (US)

(21) Appl. No.: 14/757,420

(22) Filed: Dec. 23, 2015

Related U.S. Application Data
(60) Provisional application No. 62/096,492, filed on Dec. 23, 2014.

(51) Int. Cl. G06Q 10/06

(52) U.S. Cl. CPC G06Q 10/06311

(57) ABSTRACT

A computer program product, method and system that includes a processor obtaining data from at least two vendors, where the information includes a service area for each vendor, availability information related to each vendor, and services provided by each vendor. The processor obtains a request from a client for at least one service where the request includes a location for the at least one service. The processor determines whether the request specifies a particular vendor and if so, assigns the request to the particular vendor, the processor assigns, where the assigning comprises scheduling the at least one service for the particular vendor at a time when a tolerance of the particular vendor is not exceeded. Based on determining that the request does not specify a particular vendor, the processor assigns the request to a vendor at a time when a tolerance of the vendor is not exceeded.

### CROSS-REFERENCED APPLICATION

This application claims priority from U.S. provisional patent applications, Ser. No. 62/096,492 filed on Dec. 23, 2014, entitled “Providing On Demand and Scheduled Home Services Using Dynamic Routing Through the Use of Mobile Computing Devices,” which is incorporated herein by reference, in its entirety, for all purposes

### TECHNICAL FIELD

One or more aspects of the present invention relate to routing mobile computing users effectively and efficiently to locations.

### BACKGROUND

Scheduling home maintenance services is can often be an inconvenient process. Technology used to schedule and track such appointments typically does not go beyond the telephone. Certain services, such as lawn maintenance services, require a service provider to move from location to location. When the locations are geographically dispersed and the/or the order of the services to provide comprises a route that is not efficient, time-wise, given the locations, providing the services can be more costly to the provider than any income generated from payment on the services. Even if not more costly, the costs, including the wear and tear on vehicles utilized to navigate between service locations, the gas for the transportation, and the time lost due to the travel, may outweigh the financial compensation for the services provided

### SUMMARY

Shortcomings of the prior art are overcome and additional advantages are provided through the provision of a method of efficiently routing service providers. The method includes, for instance: obtaining, by a processor, data from at least two vendors, wherein the information comprises a service area for each vendor, availability information related to each vendor, and services provided by each vendor; obtaining, by the processor, a request from a client for at least one service, wherein the request comprises a location for the at least one service; based on obtaining the request, determining, by the processor, whether the request specifies a particular vendor of the at least two vendors; based on determining that the at least one request specifies the particular vendor, assigning, by the processor, the at least one service to the particular vendor, wherein the assigning comprises scheduling the at least one service for the particular vendor at a time when a tolerance of the particular vendor is not exceeded, and wherein the particular vendor comprises an assigned vendor; and based on determining that the at least one request does not specify a particular vendor, assigning, by the one or more processor, the at least one request to a vendor of the at least two vendors, the assigning comprising: obtaining, by the processor, dynamic data related to at least one of the location of the at least one service or a location of a vendor of the at least two vendors; and based on the information from the at least two vendors and the dynamic data, assigning, by the processor, the at least one service to the vendor at a time when a tolerance of the vendor is not exceeded, wherein the vendor comprises the assigned vendor.

Computer systems, computer program products, and methods relating to one or more aspects of the technique are also described and may be claimed herein. Further, services relating to one or more aspects of the technique are also described and may be claimed herein.

Additional features and are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawings in which:

FIG. 1 depicts a hardware overview of a computing node, in accordance with one or more aspects of the present invention;

FIG. 2 depicts a hardware overview of a mobile computing node, in accordance with one or more aspects of the present invention;

FIG. 3 depicts a technical architecture that illustrates aspects of an embodiment of the present invention;

FIG. 4 depicts a workflow of an embodiment of the present invention;

FIG. 5 depicts an example of a graphical user interface utilized of an embodiment of the present invention;

FIG. 6 depicts an example of a graphical user interface utilized of an embodiment of the present invention;

FIG. 7 depicts an example of a report generated by an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

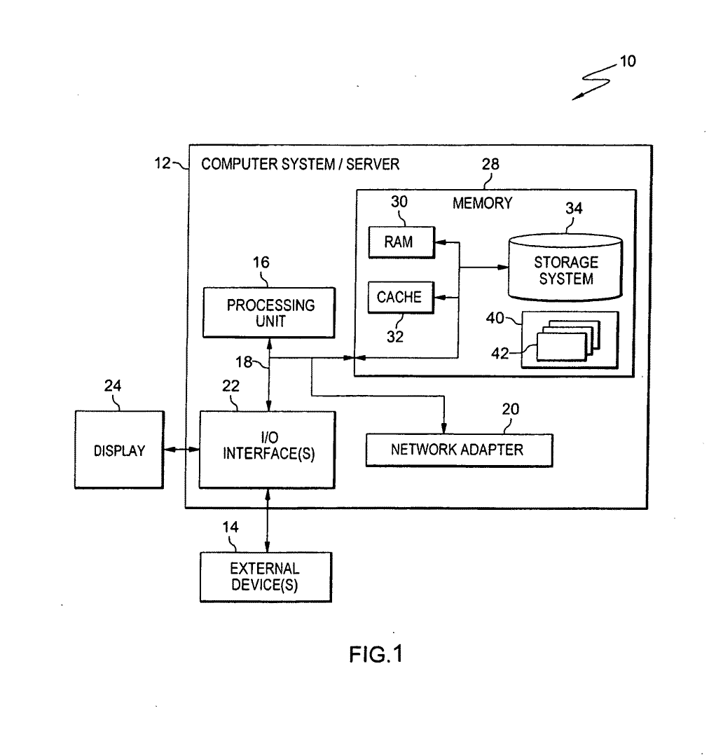

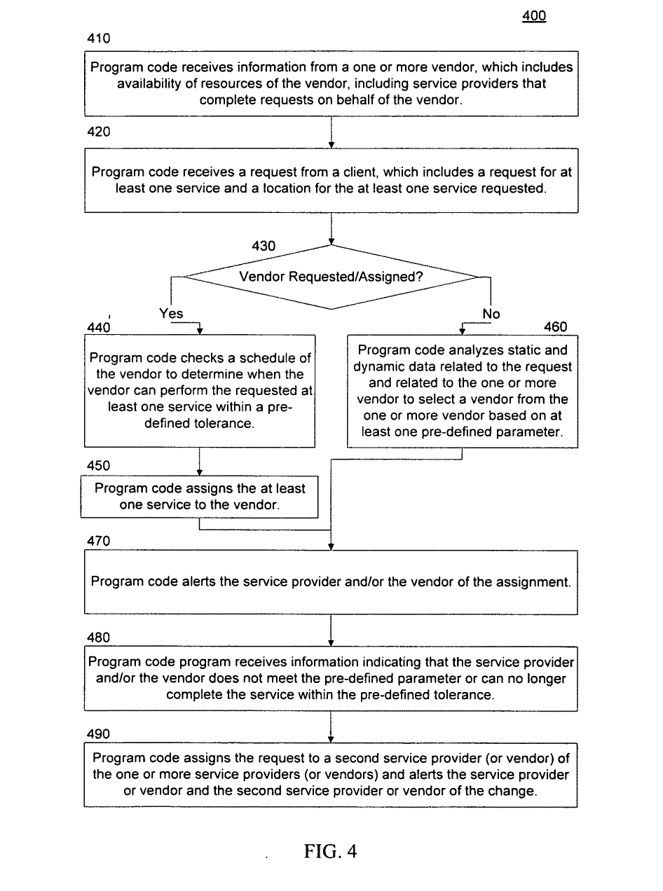

In an embodiment of the present invention, one or more program 440 (FIG. 1), also referred to herein as program code, which may be software and/or hardware, obtains a request for services that includes information about the service and location data (e.g., an address) related to where the service is to be provided. The one or more program 400 utilizes the information in the request, as well as both static and dynamic data related to service providers to select a service provider for the request and to deliver the request to the selected service provider. The static information may be stored on a memory device, such a system memory 28 (FIG. 4) and the dynamic data may include, but is not limited to, current locations of service providers and/or locations of individuals who will perform the service on behalf of the service providers, locations of vehicles utilized to provide the service, anticipated locations of the service providers and/or locations of individuals who will perform the service on behalf of the service providers at various times, location of services scheduled and to be scheduled for the day, distances between service locations, service areas services by service providers, distances of service providers from service locations, traffic, and/or weather.

In an embodiment of the present invention, the one or more program 440 provides information to a user that enables a user to select a service provider to perform a requested service. For example, one or more program 440 indicates that a service provider is out of a convenient geographic range on a given day, but within the convenient geographic range of the requestor on another day. Based on this information, the user may request that this service provider provide the requested service on the day on which the service provider is within the convenient geographic area. If the user making the request does not have an expectation that a service with be provided right away, the one or more program 440 offers flexibility in the selection of the service provider in this manner, but maintains the routing efficiency for the service providers by scheduling the service requested when it is convenient and efficient for a requested service provider to provide the service to the requestor. In an embodiment of the present invention, the one or more program 400 may prevent a user from scheduling a service with a given service provider at a time and/or on a day when the one or more program 440 has determined that it not possible and/or efficient for the service provider to provide the requested service.

In an embodiment of the present invention, the request for services may include information identifying a given service provider, for example, the request may be a recurring service request generated by a maintenance subscription of a given user, or the request may be an on-demand order specifying a particular service provider. In these situations, the one or more program 440 may assign the services underlying the request to the vendor identified in the request and add the services to the service provider's schedule when the service provider, or an individual working on behalf of the service provider, has existing jobs in that same geographic region as the requestor.

In an embodiment of the present invention, the one or more program 400 may obtain the dynamic information in real-time, responsive to receiving the request. In an embodiment of the present invention, the one or more program 440 may obtains updates to the dynamic information and based on these updates, may change the service provider for a given request.

Embodiments of the present invention are tied to computer technology because in these embodiments, one or more program 440 utilizes various types of data produced and collected by computing devices, including, but not limited to, global positioning system (GPS) data, weather-related data, and traffic-related data, to match a service provider to a requested service. Additionally, the connectivity between service providers and the one or more program 440 executing on a processor that is assigning and updating the requests, which is provided by a wireless network, such as the Internet, ties the present invention to computer technology. On-going communications with mobile computing devices over a network enable the dynamic aspects of certain embodiments of the present invention. For example, one or more program 440 in an embodiment of the present invention utilizes static and dynamic data to select a service provider for a given request. The service provider is selected because adding this service to the list of services already assigned to the service provider will result in an efficient route for the service provider. In an embodiment of the present invention, the one or more program 440 selects a service provider by updating a schedule of the service provider to include the assigned service(s). However, when the GPS data related to the position of a selected service provider, and/or of the individuals who will perform the requested service on behalf of the selected service provider, changes, for example, the GPS data could indicate that the a given service provider is no longer the most efficient choice to fulfill a given request, the one or more program 440 may change the requests assigned to this service provider and alert the service provider(s) affected by the change to this change in real-time. This dynamic exchange, which is an aspect of the present invention, is tied to the communications enabled by the use of the Internet and/or a wireless network between service providers and a processor executing the one or more program 440 that assigns requests to service providers and continuously updates these assignments based on changes to both static and and/or dynamic data.

An advantage of certain embodiments of the present invention is that in these embodiments, one or more program 440 schedules service requests for a given service provider in a manner that providers that service provider with an efficient route. The efficient route enables the service provider, by following the route, to provide the individual services that comprise the route in a manner that is profitable for that particular day.

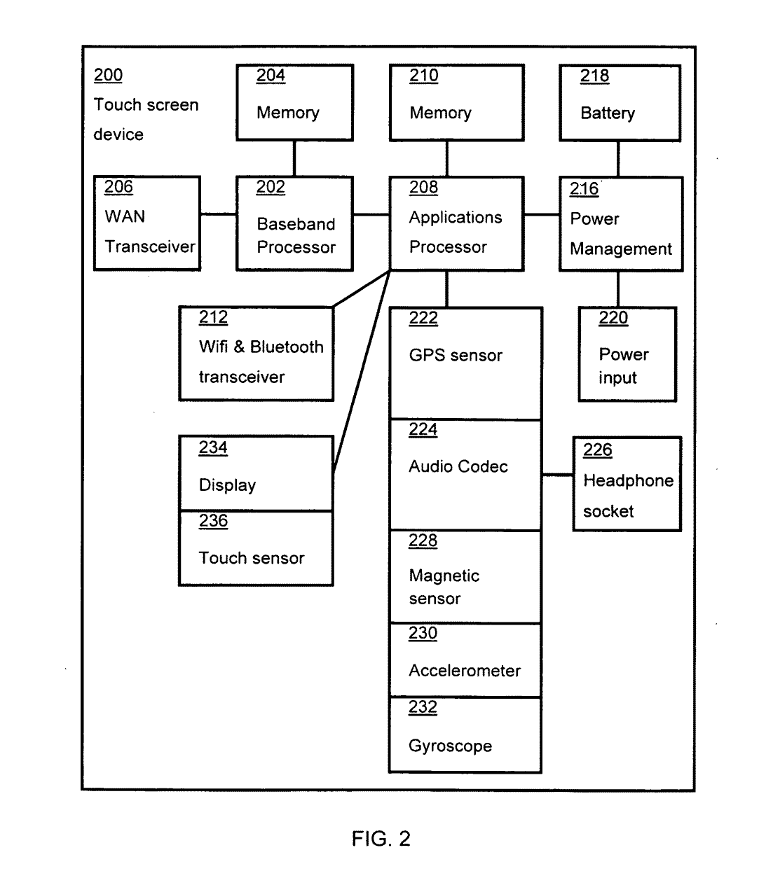

Before discussing aspects of embodiments of the present invention in more detail, FIGS. 1-2 provide descriptions of a computing environments where certain aspects of the present invention may be implemented. FIG. 1 provides a general description of a computing node 10. As discussed above, aspects of the present invention rely on the interconnectivity between different computing nodes 10 over a computer network. FIG. 2 illustrates a touch screen device 200, which is a type of computing node 10 (FIG. 1) that can be utilized in embodiments of the present invention. The mobile computing device in FIG. 2 is discussed separately as certain functionality, such as a global positioning system (GPS), is more often found in mobile computing devices and is utilized in embodiments of the present invention.

FIG. 1 depicts various aspects of a computing environment that can be utilized in accordance with one or more aspects set forth herein. Specifically, FIG. 1 depicts a hardware overview of a computing node 10, in accordance with one or more aspects set forth herein.

Referring now to FIG. 1, a schematic of an example of a computing node, which can include a cloud computing node, is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, mobile devices, personal data assistants, and distributed cloud computing environments that include any of the above systems or devices, and the like.

Referring to FIG. 1, computer system 12 may be described in the general context of computer system-executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing node 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer. system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

Program/utility 40 as set forth in FIG. 1 can include one or more program 440, and program/utility 40, including, for example one or more program 440 to evaluate the efficacy of the communications between one or more entities when transferring task ownership between these entities, as described in work layer 96. Program/utility 40 as set forth in FIG. 1 can optionally include additional programs.

One or more program 440 can have a set (at least one) of program modules, and may be stored in memory 28 by way of example, and not limitation, as well as an operating system, one or more application programs, other program modules, and program data. Each of the operating system, one or more application programs, other program modules, program data, and one or more program, or some combination thereof, may include an implementation of a networking environment. One or more program 440 generally carry out the functions and/or methodologies of embodiments of the invention as described herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As understood by one of skill in the art, the computing node 10 of FIG. 1 may include a mobile computing device, such as a touch screen device. FIG. 2 shows a block diagram of a touch screen device 200 in which one or more aspects of the present invention may be implemented. Baseband processor 202 in a network interface manages the radio functions that require an antenna. In the example of FIG. 2, this is the Wide Area Network (WAN) transceiver 206 which provides communication with a WAN such as the Internet. Baseband processor 202 is also connected to memory 204 and to applications processor 208. Applications processor 208 is a chip in the touch screen device 200 that can run an operating system and applications software. Applications processor 208 is connected to memory 210 for the storage of the operating system, applications software and data. Applications processor 208 is also connected to Wifi & Bluetooth® transceiver 212. In certain touch screen devices 200, Wifi & Bluetooth transceiver 212 may alternatively be connected to baseband processor 202. Applications processor 208 is also connected to power management 216 which manages the power from power input 220 and from battery 218 to supply power to the touch screen device 202 to operate and to the battery 218 to recharge it. Also connected to applications processor 208 are Global Positioning System (GPS) sensor 222 to provide geographical position information to applications processor 208 and audio codec 224 to receive audio data from applications processor 208 and output it to headphone socket 226 and to a loudspeaker (not shown). Applications processor 208 is further connected to magnetic sensor 228 which may provide input to allow the device to act as a compass. Particular touch screen devices 202 may not have all of the items described above such as, for example, Wifi & Bluetooth transceiver 212, GPS sensor 222 or magnetic sensor 228. An example of such an magnetic sensor is the AKM8975 available from AKM Semiconductor. Particular touch screen devices 200 may have additional items not described above, for example, external display or network connections. As aforementioned, computing nodes utilized in embodiments of the present invention communication via network connections.

Returning to FIG. 2, applications processor 208 is also connected to display 234 for displaying data to a user and touch sensor 236 for receiving touch input from a user. Applications processor 208 is further connected to accelerometer 230 and gyroscope 232. Accelerometer 230 allows the touch screen device 202 to detect its orientation and adapt the content shown on the display 234 to fit different orientations of the display.

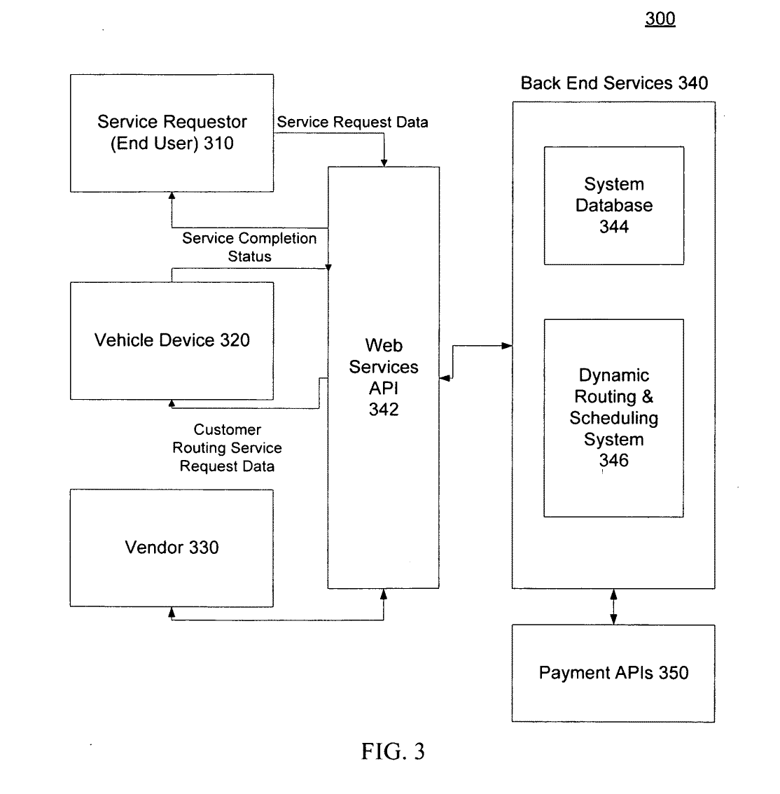

FIG. 3 is an overview of an architecture for an embodiment of the present invention. In this example architecture, the Service Requestor (End User) 310, Vehicle Device 320, Vendor 330, and Back End Services 340 each comprise one or more computing nodes 10 (FIG. 1). In an embodiment of the present invention, one or more of these computing nodes 10 (FIG. 1) may be mobile devices which may be touch screen devices 200 (FIG. 2). For ease of understanding, in FIG. 3, individuals who sell the services requested are termed “vendors,” while individuals who provide the services on behalf of the vendors are referred to as “service providers.” A vendor and a service provider may be separate entities or a single entity.

In an embodiment of the present invention, one or more program 440 (FIG. 1), which is depicted in FIG. 3 as Back End Services 340, obtain(s) data from various clients. For example, the Back End Services 340 obtain service requests from the Service Requestor (End User) 310. Additionally, the Back End Services 340 obtain availability information from one or more vendor, e.g., Vendor 330. The availability information can comprise both the hours that a given vendor's service providers are available to provide services and what services that vendor is available to provide. The vendor information obtained by the Back End Services 340 may also include vendor/truck location and the service area in which the vendor provides services.

In the embodiment of FIG. 3, the Back End Services 340 obtain the information from the vendors and the prospective clients (end users, which may include resellers of services) Web Services Application Programming Interface (API) 342. However, this is merely one example of a possible technical architecture for embodiments of the present invention and is offered for ease of understanding only. Once the Back End Services 340 obtain the data via the Web Service API 342, the one or more program 440 (FIG. 1) that provides a front end to the Back End Services 340 may save the data in a System Database 344, which may be a memory 28 (e.g., FIG. 1). The front end Web Service API 342 is part of the Back End Services 340 in an embodiment of the present invention.

The one or more programs 440 (FIG. 1) that comprise the Back End Services 340 in this embodiment include(s) a module referred to in FIG. 3 as the Dynamic Routing & Scheduling System 346. The Dynamic Routing & Scheduling System 346 evaluates both the static and dynamic data obtained by the Web Service API 342 from the clients (vendors, service providers, end users), schedules the requests obtained to be fulfilled by service providers (contracted by the vendors), and alerts the vendors and/or the service providers as to which requests the service providers are responsible for. In an embodiment of the present invention, the Dynamic Routing & Scheduling System 346 compiles a list of requests (jobs) assigned to each vendor and/or service provider on a given day.

In an embodiment of the present invention, the one or more program 440 enables the end user to select a service provider and/or vendor for a given service. However, the service providers and vendors offered for selection are those that are available to provide the service (e.g., within the specified service area, capable of providing the service requested) and can provide the service within the tolerance. In an embodiment of the present invention, the one or more program 440 may provide a user with the option of scheduling a service on a day in the future based on the vendor and/or service provider selected by the user being available that day (and/or time) and able to provide the service at the suggested time within the pre-defined tolerance.

In an embodiment of the present invention, the Dynamic Routing & Scheduling System 346 automatically assigns the requested maintenance and/or service to a specific vendor and/or service provider. In an embodiment of the present invention, the one or more program enables a user to specify a specific vendor and the one or more program 440 receives this information as part of the request. In this circumstance, the one or more program 440 assigns the requested service(s) to the specified vendor and/or service provider. In an embodiment of the present invention, when the one or more program 440 receives a request for service that is a recurring orders for routine maintenance and/or service, the Dynamic Routing & Scheduling System 346 automatically assigns the requested maintenance and/or service to the service provider or vendor who generally provides this service/maintenance. When the one or more program 440 assigns a service to a specific vendor (and/or service provider), in either of the scenarios described above, the one or more program 440 schedules the service visit associated with the requested service on that vendor's schedule when the vendor has existing jobs for that day in that same general geographic region. If an end requests a service request with no vendor preference, the end user will be assigned the first available vendor that services that area and the job will be added to the vendor's daily job list on a day which the vendor has existing jobs in the same general geographic region.

In an embodiment of the present invention, The Dynamic Routing and Scheduling System 346 communicates an assignment to a service provider by causing the assignment to display in a graphical user interface (GUI) of a Vehicle Device 320 of the assigned service provider. The one or more program 440 may display the services to be fulfilled by a given service provider on the Vehicle Device 320 for a given period of time, for example, the Vehicle Device 320 may display the services to be completed on a particular day. The static data refers to data that is entered into the system at various nodes by users, e.g., vendor general information, vendor availability, vendor services offered, addresses of service requestors, details of services requested, etc. Portions of the static data may be updated by a user (end user, vendor, service provider) through a client (e.g., computing node 10 (FIG. 1), touch screen device 200 (FIG. 2)).

Dynamic data refers to data that is obtained by the one or more program 440 without user intervention, such as the geographic location of various service providers, locations of service provider resources, the traffic conditions, the weather, etc. After scheduling the requests, the Dynamic Routing & Scheduling System 346 continues to receive data related to the vendors and the end users and makes changes to the scheduled requests and alerts the vendors to these changes, in real-time. The one or more programs 440 (FIG. 1) maintains communication with the vendors and the end users over a network connection to the devices that these users are accessing. Changes in both static and dynamic data may necessitate a change in scheduling. For example, a vendor may enter revised availability, which may require a change to the vendor's schedule. Additionally, the one or more program 440 (FIG. 1) may receive GPS information from a Vehicle Device 320 of a vendor that indicates that this vendor is no longer in an ideal position to provide an assigned service, while another vendor, as indicated by this vendor's Vehicle Device 320, is in a better position and available. Based on this information, the one or more program 440 (FIG. 1) may change the assignments of these vendors and display the updated schedules to the vendors of their Vehicle Devices 320.

As aforementioned, in an embodiment of the present invention, Dynamic Routing & Scheduling System 346 takes into account both static and dynamic data related to vendors, service providers, and/or end users, when scheduling a given service to be provided by a vendor, on behalf of a given service provider. In an embodiment of the present invention, the Dynamic Routing & Scheduling System 346 may schedule a vendor to provide a given service provided that the data related to the vendor and/or the service is within a certain tolerance. The tolerance may be related to the service area of the vendor, the prior services and subsequent services that the service provider is scheduled to perform on that given day and the geographical proximity of the services assigned to the given service provider in the given day. The tolerance represents thresholds that, if met, would render the service provider unable to complete the assigned services within the stipulated time (e.g., a day), and/or, if possible, would affect the profitability of the service provider as the costs to provide the assigned services in a given day would exceed the expected profits. The tolerances within the system may be pre-configured on an individual basis for vendors and/or service providers, and the one or more program 440 may evaluate whether an assignment would exceed a tolerance when making that assignment. In an embodiment of the present invention, the one or more program 440 may determine a tolerance for a given vendor or service provider based on the aforementioned static and/or dynamic data.

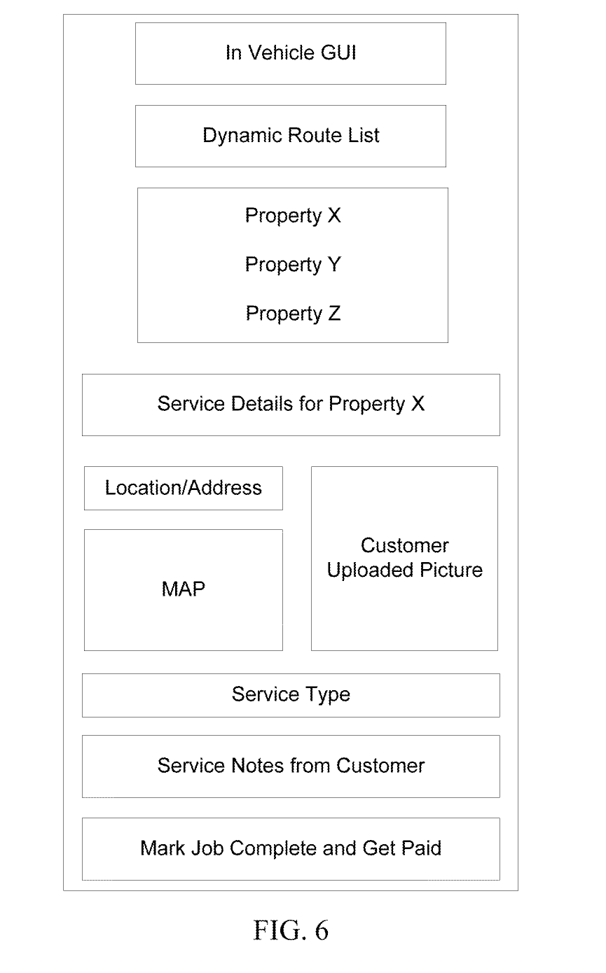

In an embodiment of the present invention, the service providers can indicate when they have completed requests by changing the status of the lists of services they have been assigned by The Dynamic Routing & Scheduling System 346. The service providers can view the list of assigned services in a GUI displayed on their Vehicle Devices 320, and make an entry to indicate that a service is complete. FIG. 6 provides an example of a list of assigned services, as displayed in the aforementioned GUI. A service provider user may touch the individual elements on the list to see more details about each service, such as the location and the contact information of the requestor.

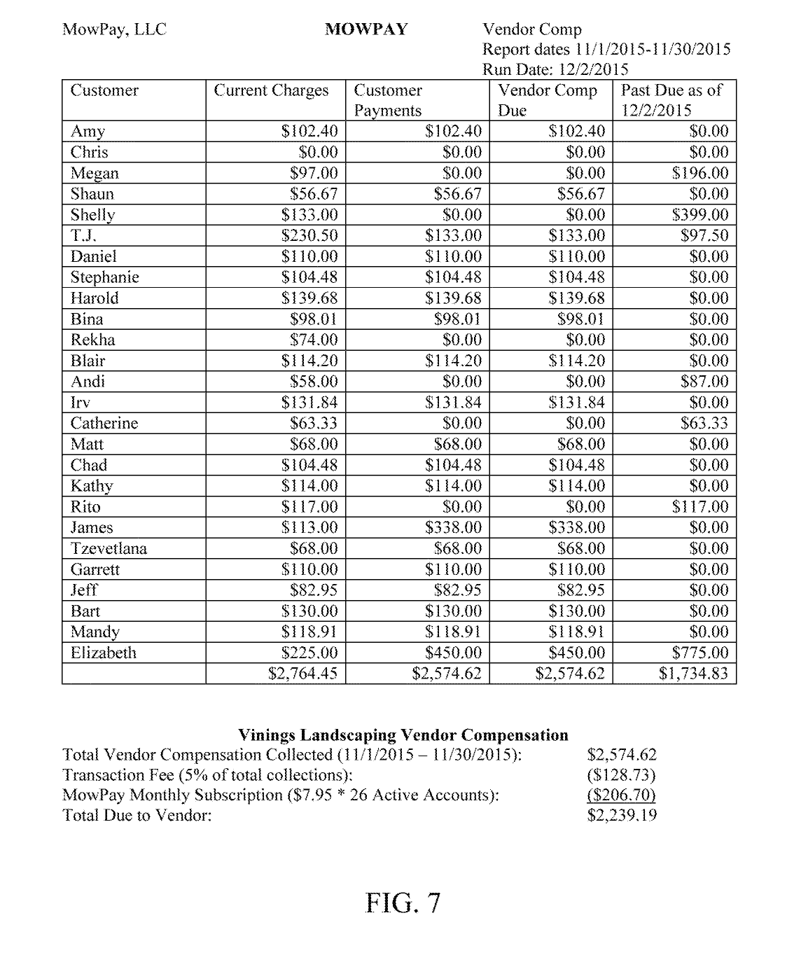

Returning to FIG. 3, the Dynamic Routing & Scheduling System 346 obtains information regarding a service being complete and may communicate this information with a billing system, for example, one or more Payment APIs 350, which may be internal and/or external to the physical machine running the Back End Services 340. The one or more Payment APIs 350 may respond to the billing request with a bill for services. The Back End Services 340 can deliver to the end user's devices. In an embodiment of the present invention, the Service Requestor (End User) 310 device may not only display a request for payment (e.g., bill) to an end user, it may also accept payment. The payment information may be obtained by the Back End Services 340 and send to the Payment APIs and/or processed as part of the Back End Services 340. In an embodiment of the present invention, the one or more program 440 may generate a settlement report for a given service provider and/or vendor. An example of such a report in FIG. 7.

The present invention is a method for requesting on demand or scheduled home maintenance services. A home maintenance request for maintenance service would be received from an end user. The maintenance request would include property location, property description and service requested, and optional picture. Service pricing and service description would be would be presented to the end user along with detailed information about the qualified service providers.

The present invention is a method for requesting on demand or scheduled home maintenance services. A home maintenance request for maintenance service would be received from an end user. The maintenance request would include property location, property description and service requested, and optional picture. Service pricing and service description would be would be presented to the end user along with detailed information about the qualified service providers. End user would select to schedule a onetime service or schedule reoccurring services. A prompt is provided for the user to confirm the maintenance request. A prequalified service provider would be assigned based on the most efficient route for that day and the customer would be notified of the assigned service provider and estimated time of service. One or more processors determine the best routing based on services provided, distance, traffic, weather or any other data that would help to generate a route most efficient for any particular day. Routes would dynamically change based on multiple factors and display on a mobile computing device in the service providers vehicle. Additional information about that maintenance service appointment would also display in the service providers mobile computing device and service information could dynamically change at any time based on customer input, weather, traffic, distance or any other data that might affect the service or efficiency of routing.

FIG. 4 is a workflow 400 that illustrates certain aspects of an embodiment of the present invention. In an embodiment of the present invention, one or more program 440 receives information from a one or more vendor, which includes availability of resources of the vendor, including service providers that complete requests on behalf of the vendor (410). The information may include the availability of the vendor, the locations of the resources of the vendor, and the service area serviced by the vendor and/or by the resources of the vendor.

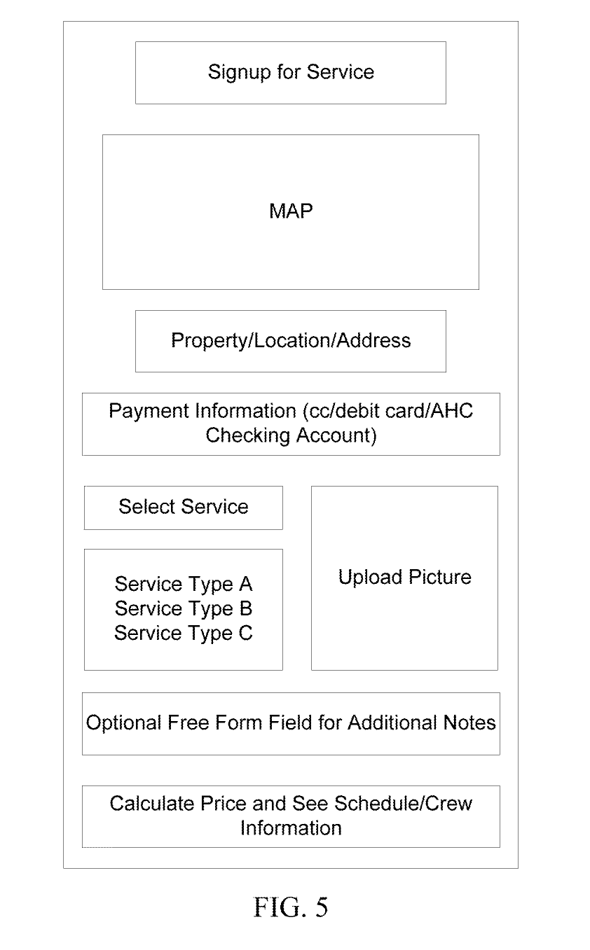

The one or more program 440 receives a request from a client, which includes a request for at least one service and a location for the at least one service requested (420). In an embodiment of the present invention, the request includes, but is not limited to, a service type for each of the at least one service requested, details related to the location(s), and/or selection of a vendor. In an embodiment of the present invention, the one or more program 440 accumulates service requests in a dynamic routing queue. FIG. 5 is an example of a graphical user interface that may be used by a client to enter a request for services.

In an embodiment of the present invention, the one or more program 440 checks to see whether the request includes a vendor or if the request and/or if the request is part of a subscription for recurring services previously assigned to a vendor (430). Based on determining that either the request includes a vendor or that the request is part of a subscription for recurring services previously assigned to a vendor, the one or more program 440 checks a schedule of the vendor to determine when the vendor can perform the requested at least one service within a pre-defined tolerance (440). Based on locating a place in the schedule of the vendor where completing the service enables the vendor to remain within the predefined tolerance, the one or more program 440 assigns the at least one service to the vendor (450). In an embodiment of the present invention, the one or more program 440 does not route requests that specify a given vendor (either as an on-demand service or as part of a subscription) are no stored in a queue before being assigned, in this embodiment, only requests that do not include a specific vendor are routed to the queue before being assigned to vendors.

In an embodiment of the present invention, the tolerance for each vendor is pre-configured by a vendor. In an embodiment of the present invention, the one or more program 440 determined the tolerance of a vendor based upon information, including but not limited to, the service area of a vendor, the distances between service calls assigned to a given vendor on a given day, the weather during a given period of time in the service area of the vendor, the traffic during a given area of time in the service area of the vendor, etc.

Returning to FIG. 4, based on determining that the does not include a vendor and is not part of a previously-assigned subscription for recurring services, the one or more program 440 analyzes static and dynamic data related to the request and related to the one or more vendor to select a vendor from the one or more vendor based on at least one pre-defined parameter (460). Criteria for selecting a vendor is discussed earlier in this paper and includes both data entered by a vendor and dynamic data that is obtained by the one or more program 440, including the GPS data of devices utilized by vendors and the weather and traffic reports in the service areas of the vendors and at the location related to the at least one request.

Based on selecting the service provider, the one or more program alerts the service provider and/or the vendor of the assignment (470). In an embodiment of the present invention, the one or more program 440 provides the alert by populating the service assigned in a GUI on the mobile device utilized by the vendor and/or the service provider. The vendor and/or service provider can utilize this same GUI to mark a specific request complete. FIG. 6 is an example of this type of GUI.

Returning to FIG. 4, in an embodiment of the present invention, the one or more program receives information indicating that the service provider and/or the vendor does not meet the pre-defined parameter or can no longer complete the service within the pre-defined tolerance (480). Based on this information, the one or more program assigns the request to a second service provider or vendor of the one or more service providers or vendor and alerts the service provider and the second service provider of the change (490).

An advantage of certain embodiments of the present invention is that the aforementioned efficient routing of vendors in service providers enables a large group of service providers and vendors to participate. Service providers and vendors utilizing aspects of embodiments of the present invention include, but are not limited to: 1) Individual Owner/Operators, including landscapers, plumbers, and maids with one vehicle performing service calls one visit at a time; 2) Service Companies, which include companies employing multiple employees, with multiple vehicles dispatching to multiple service calls simultaneously; 3) Re-sellers of services; including but not limited to Amazon®, Google Home Services, and Angie's List®; and 4) Vendor Subscribers, which include individual owner/operators or small companies without their own technology systems. Resellers may connect to the Back End Services 340 (FIG. 3) of embodiments of the present invention utilizing APIs, including proprietary APIs, while embodiments of the present invention may include a GUI that enables Vendor Subscribers to access aspects of the present invention, including the Back End Services 340.

The specific non-limiting example that follows demonstrates various aspects of certain embodiments of the present invention and is offered for ease of understanding. To further illustrate this example, references are made to aspects the invention as illustrated by FIG. 3. Individual operator (e.g., John Doe) or crew from a big landscaping company (e.g., Crew XYZ from US Lawns) are in transit to their next service call. Both Doe and Crew xyz utilize a Vehicle Device 320 communicates with the Back End Services 340 over a wireless connection, including but not limited to, the Internet.

A new customer purchases a lawn service visit from a re-sellers or from an individual operator. The new customer would utilize a computing resource to make the request; the resource is identified in FIG. 3 as a Service Requestor (End User) 310. Based on the connection of the re-seller or the individual operator, the Service Requestor (End User) 310 may comprise the website of a reseller, that connect to the Back End Services 340 via an API, or the Service Requestor (End User) 310 may comprise a GUI interface that enables the Back End Services 340 to obtain the request information. Because the service is purchased from a specific vendor (re-seller or individual), the one or more program 440 will attempt to assign the service to the specific vendor.

The one or more program 440 (FIG. 4) obtains the request (purchase) of the new customer from the Service Requestor (End User) 310, and based on factors including, but not limited to, the availability of the specified vendor(s), the services offered by the specified vendor(s), and vehicle location(s) of the vehicle(s) of the specified vendor(s), selects the specified vendor, assigns the specified vendor to the service, and schedules the visit on the specified vendor's or the crew's service route.

In an embodiment of the present invention, the customer may not specify the vendor, or may not order the service is a manner where the vendor is pre-selected, including but not limited to using the website of a service provider to order the service. As aforementioned, the one or more program will assign a vendor to the service(s) requested. In one example, a customer enters as order and the customer's property is located directly on the current route of Crew XYZ from US Lawns to its next service call. As described above in reference to FIGS. 3-4, the one or more program analyzes all vendor subscriber schedules (e.g., through API Sync or subscribers to the service), to identify a vendor who's schedule(s) are best likely to accommodate that request as quickly as possible. Utilizing both the static data and dynamic data, in this case, location information related to the current location of Crew XYZ from US Lawns, the one or more program determines that this vendor is the closest provider to the customer's property and can provide this service within any additional parameters, the one or more program 440 assigns the service requested to the Crew XYZ from US Lawns.

Upon assigning the service to Crew XYZ, the one or more program 440 alerts the vendor to the new assignment by displaying the property where the service will be provided as the driver's next service call in a Vehicle Device 320 utilized by Crew XYZ. The dynamic update to the list of services assigned to Crew XYZ enable Crew XYZ from US Lawns to show up to the customer's property and perform the service.

As can been seem from the example above, advantages of certain embodiments of the present invention may include, but are not limited to: 1) a customer receives nearly immediate service meeting on-demand economy SLA expectations; 2) a service provider does not have to expend any unnecessary resources to arrive at their next service location saving time, gas, wear on vehicle, etc.; 3) the service provider's operating budget is reduced; 3) the environmental impacts of the vehicles utilized by the service providers are reduced as the increased efficiency in the routing of these vehicles decreases vehicle transits distances.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A method comprising:
obtaining, by a processor, data from at least two vendors, wherein the information comprises a service area for each vendor, availability information related to each vendor, and services provided by each vendor;
obtaining, by the processor, a request from a client for at least one service, wherein the request comprises a location for the at least one service;
based on obtaining the request, determining, by the processor, whether the request specifies a particular vendor of the at least two vendors;
based on determining that the at least one request specifies the particular vendor, assigning, by the processor, the at least one service to the particular vendor, wherein the assigning comprises scheduling the at least one service for the particular vendor at a time when a tolerance of the particular vendor is not exceeded, and wherein the particular vendor comprises an assigned vendor; and
based on determining that the at least one request does not specify a particular vendor, assigning, by the one or more processor, the at least one request to a vendor of the at least two vendors, the assigning comprising:
obtaining, by the processor, dynamic data related to at least one of the location of the at least one service or a location of a vendor of the at least two vendors; and
based on the information from the at least two vendors and the dynamic data, assigning, by the processor, the at least one service to the vendor at a time when a tolerance of the vendor is not exceeded, wherein the vendor comprises the assigned vendor.

2. The method of claim 1, wherein the determining that the request specifies a particular vendor of the at least two vendors comprises at least one of:
determining, by the processor, that the request comprises data specifying the particular vendor; or
determining, by the processor, that the request comprises a request for a recurring service, wherein the recurring service is a series of services and a completed service in the series was assigned to the particular vendor.

3. The method of claim 1, further comprising:
based on the assigning of the at least one service to the assigned vendor, notifying, by the processor, the assigned vendor of the assigning.

4. The method of claim 1, further comprising:
monitoring, by the processor, the dynamic data to identify a change in the dynamic data; and
assigning, by the processor, the at least one service to a second vendor of the at least two vendors based on identifying, by the processor, the change in the dynamic data, wherein based on the change, the assigning the at least one service to the assigned vendor exceeds the tolerance of the assigned vendor.

5. The method of claim 4, further comprising:
notifying, by the processor, the second vendor and the assigned vendor of the assigning the at least one service to the second vendor.

6. The method of claim 1, further comprising:
obtaining, by the processor, an indication that the assigned vendor has completed the at least one service; and
based on the obtaining, requesting, by the processor, billing information related to the at least one service from a billing system.

7. The method of claim 1, wherein the at least one service comprises more than one service and the vendor of the at least two vendors comprises more than one vendor.

8. The method of claim 1, wherein the dynamic data comprises at least one of location data, weather data, or traffic data.

9. The method of claim 8, wherein the dynamic data comprises location data and the location data comprises global positioning data from a mobile device at a location of the assigned vendor.

10. The method of claim 8, wherein the dynamic data comprises traffic data and the traffic data comprises data related to traffic at a location of the assigned vendor.

11. A computer program product comprising:
a computer readable storage medium readable by a processor and storing instructions for execution by the processor for performing a method comprising:
obtaining, by the processor, data from at least two vendors, wherein the information comprises a service area for each vendor, availability information related to each vendor, and services provided by each vendor;
obtaining, by the processor, a request from a client for at least one service, wherein the request comprises a location for the at least one service;
based on obtaining the request, determining, by the processor, whether the request specifies a particular vendor of the at least two vendors;
based on determining that the at least one request specifies the particular vendor, assigning, by the processor, the at least one service to the particular vendor, wherein the assigning comprises scheduling the at least one service for the particular vendor at a time when a tolerance of the particular vendor is not exceeded, and wherein the particular vendor comprises an assigned vendor; and
based on determining that the at least one request does not specify a particular vendor, assigning, by the one or more processor, the at least one request to a vendor of the at least two vendors, the assigning comprising:
obtaining, by the processor, dynamic data related to at least one of the location of the at least one service or a location of a vendor of the at least two vendors; and
based on the information from the at least two vendors and the dynamic data, assigning, by the processor, the at least one service to the vendor at a time when a tolerance of the vendor is not exceeded, and wherein the vendor comprises the assigned vendor.

12. The computer program product of claim 11, wherein the determining that the request specifies a particular vendor of the at least two vendors comprises at least one of:
determining, by the processor, that the request comprises data specifying the particular vendor; or
determining, by the processor, that the request comprises a request for a recurring service, wherein the recurring service is a series of services and a completed service in the series was assigned to the particular vendor.

13. The computer program product of claim 11, further comprising:
based on the assigning of the at least one service to the assigned vendor, notifying, by the processor, the assigned vendor of the assigning.

14. The computer program product of claim 11, further comprising:
monitoring, by the processor, the dynamic data to identify a change in the dynamic data; and
assigning, by the processor, the at least one service to a second vendor of the at least two vendors based on identifying, by the processor, the change in the dynamic data, wherein based on the change, the assigning the at least one service to the assigned vendor exceeds the tolerance of the assigned vendor.

15. The computer program product of claim 14, further comprising:
notifying, by the processor, the second vendor and the assigned vendor of the assigning the at least one service to the second vendor.

16. The computer program product of claim 11, further comprising:
obtaining, by the processor, an indication that the assigned vendor has completed the at least one service; and
based on the obtaining, requesting, by the processor, billing information related to the at least one service from a billing system.

17. The computer program product of claim 11, wherein the at least one service comprises more than one service and the vendor of the at least two vendors comprises more than one vendor.

18. The computer program product of claim 11, wherein the dynamic data comprises at least one of location data, weather data, or traffic data.

19. The computer program product of claim 18, wherein the dynamic data comprises location data and the location data comprises global positioning data from a mobile device at a location of the assigned vendor.

20. A system comprising:
a memory;
a processor in communication with the memory; and
program instructions executable by a processor via the memory to perform a method, the method comprising:
obtaining, by the processor, data from at least two vendors, wherein the information comprises a service area for each vendor, availability information related to each vendor, and services provided by each vendor;
obtaining, by the processor, a request from a client for at least one service, wherein the request comprises a location for the at least one service;
based on obtaining the request, determining, by the processor, whether the request specifies a particular vendor of the at least two vendors;
based on determining that the at least one request specifies the particular vendor, assigning, by the processor, the at least one service to the particular vendor, wherein the assigning comprises scheduling the at least one service for the particular vendor at a time when a tolerance of the particular vendor is not exceeded, and wherein the particular vendor comprises an assigned vendor; and
based on determining that the at least one request does not specify a particular vendor, assigning, by the one or more processor, the at least one request to a vendor of the at least two vendors, the assigning comprising:
obtaining, by the processor, dynamic data related to at least one of the location of the at least one service or a location of a vendor of the at least two vendors; and
based on the information from the at least two vendors and the dynamic data, assigning, by the processor, the at least one service to the vendor at a time when a tolerance of the vendor is not exceeded, and wherein the vendor comprises the assigned vendor.
